(19) United States
(12) Patent Application Publication
(10) Pub. No.: US 2019/0384031 A1
(43) Pub. Date: Dec. 19, 2019

(54) OPTICAL UNIT

(71) Applicant: OLYMPUS CORPORATION, Tokyo (JP)

(72) Inventors: Junichi OKUBO, Hirosaki-shi (JP); Keiichi ASAMI, Tokyo (JP)

(73) Assignee: OLYMPUS CORPORATION, Tokyo (JP)

(21) Appl. No.: 16/554,923

(22) Filed: Aug. 29, 2019

Related U.S. Application Data
(63) Continuation of application No. PCT/JP2018/003364, filed on Feb. 1, 2018.

(30) Foreign Application Priority Data
Mar. 2, 2017 (JP) 2017-039415

(51) Int. Cl. G02B 7/02; B23K 26/282; B23K 26/32; H04N 5/225

(52) U.S. Cl. CPC G02B 7/02; H04N 5/2254; B23K 26/32; B23K 26/282

(57) ABSTRACT

An optical unit includes: a first optical device retaining body including a first retainer, and a first fitting margin; a second optical device retaining body including a second retainer, and a second fitting margin; and a weld portion melted and solidified across the first fitting margin and the second fitting margin, the weld portion being provided in an edge surface located outside a region in an optical axis direction of the optical unit, the region being sandwiched by: a first retaining surface passing through the first retainer and perpendicular to the optical axis of the optical unit; and a second retaining surface passing through the second retainer and perpendicular to the optical axis, wherein ends of the first fitting margin and the second fitting margin in the optical axis direction in the overlapping portion are substantially aligned at the edge surface.

This application is a continuation of PCT International Application No. PCT/JP2018/003364 filed on Feb. 1, 2018, which designates the United States, incorporated herein by reference, and which claims the benefit of priority from Japanese Patent Application No. 2017-039415, filed on Mar. 2, 2017, incorporated herein by reference.

### BACKGROUND

The present disclosure relates to an optical unit.

In an optical unit used for industrial use, relative positions of lenses are adjusted in accordance with, for example, characteristics of a photoelectric conversion element in order to obtain desired optical characteristics (see, for example, JP H7-281062 A). JP H7-281062 A discloses an optical unit in which adjustment of relative positions between a lens holder that retains a lens and a laser holder that retains a semiconductor laser is performed, and then, the holders are fixed by laser welding.

FIG. 21 is a schematic view illustrating a configuration of an optical unit. An optical unit 200 illustrated in the same drawing includes: a lens 201; a substantially cylindrical lens holder 202 that retains the lens 201; a semiconductor laser 203; and a cylindrical laser holder 204 that retains the semiconductor laser 203. The lens 201 is fixed to the lens holder 202 by, for example, soldering or adhesion using an adhesive. The semiconductor laser 203 is fixed to the laser holder 204 by, for example, laser welding. Incidentally, each of a central axis of the lens holder 202 and a central axis of the laser holder 204 coincides with an optical axis N₂₀₀ of the optical unit 200.

In addition, the lens holder 202 and the laser holder 204 are fixed by laser welding. A specific fixing method will be described. First, the laser holder 204 is accommodated in the lens holder 202, and then, a position of the laser holder 204 relative to the lens holder 202 is adjusted such that the lens 201 and the semiconductor laser 203 satisfy preset optical conditions. The position of the laser holder 204 is adjusted, for example, such that a distance d₂₀₀ between the lens 201 and a light source 203a of the semiconductor laser 203 becomes a preset distance. Thereafter, a laser beam is emitted from an outer circumferential side of the lens holder 202 to weld the lens holder 202 and the laser holder 204. With this laser welding, a weld portion 205 is formed on the lens holder 202 and the laser holder 204 as melted portions thereof are mixed and solidified. In this manner, the lens holder 202 and the laser holder 204 are fixed.

### SUMMARY

According to one aspect of the present disclosure, there is provided an optical unit including: a first optical device retaining body having a sleeve-shape and including a first retainer configured to retain a first optical device thereinside, and a first fitting margin extending from the first retainer; a second optical device retaining body having a sleeve-shape and including a second retainer configured to retain a second optical device thereinside, and a second fitting margin extending from the second retainer, wherein the first fitting margin and the second fitting margin are fitted with each other, and the optical unit is fixed by welding at an overlapping portion of the first fitting margin and the second fitting margin; and a weld portion melted and solidified across the first fitting margin and the second fitting margin, the weld portion being provided in an edge surface located outside a region in an optical axis direction of the optical unit, the region being sandwiched by: a first retaining surface passing through the first retainer and perpendicular to the optical axis of the optical unit; and a second retaining surface passing through the second retainer and perpendicular to the optical axis, wherein ends of the first fitting margin and the second fitting margin in the optical axis direction in the overlapping portion are substantially aligned at the edge surface.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view schematically illustrating a configuration of an optical unit according to a first embodiment;

FIG. 2 is a partial cross-sectional view schematically illustrating the configuration of the optical unit according to the first embodiment;

FIG. 3 is a view for describing a method for measuring a dimensional change at the time of melting and solidification;

FIG. 4 is a view for describing the method for measuring the dimensional change at the time of melting and solidification;

FIG. 5 is a view for describing an example of a measurement result of the dimensional change at the time of melting and solidification;

FIG. 6 is a schematic view illustrating production of the optical unit according to the first embodiment;

FIG. 7 is a view for describing shrinkage of each holder when laser welding is performed;

FIG. 8 is a cross-sectional view schematically illustrating a configuration of a main part of an optical unit according to a first modification of the first embodiment;

FIG. 9 is a perspective view schematically illustrating a configuration of an optical unit according to a second modification of the first embodiment;

FIG. 10 is a partial cross-sectional view schematically illustrating a configuration of an optical unit according to a third modification of the first embodiment;

FIG. 11 is a partial cross-sectional view schematically illustrating a configuration of an optical unit according to a fourth modification of the first embodiment;

FIG. 12 is a partial cross-sectional view schematically illustrating a configuration of an optical unit according to a second embodiment;

FIG. 13 is a partial cross-sectional view for describing production of the optical unit according to the second embodiment;

FIG. 14 is a partial cross-sectional view schematically illustrating a configuration of an optical unit according to a modification of the second embodiment;

FIG. 15 is a perspective view schematically illustrating a configuration of an optical unit according to a third embodiment;

FIG. 16 is a partial cross-sectional view schematically illustrating the configuration of the optical unit according to the third embodiment;

FIG. 17 is a partial cross-sectional view for describing production of the optical unit according to the third embodiment;

FIG. 18 is a partial cross-sectional view schematically illustrating a configuration of an optical unit according to a fourth embodiment;

FIG. 19 is a partial cross-sectional view for describing production of an optical unit according to a fifth embodiment;

FIG. 20 is a cross-sectional view schematically illustrating a configuration of a main part of the optical unit according to the fifth embodiment; and

FIG. 21 is a schematic view illustrating a configuration of an optical unit.

### DETAILED DESCRIPTION

Hereinafter, modes for carrying out the present disclosure (hereinafter, referred to as “embodiment(s)”) will be described in detail with reference to the appended drawings. The drawings are schematic, and dimensional relationships and proportions of the respective units are different from reality. In addition, the drawings may include some parts that have different dimensional relationships and ratios among the drawings.

### First Embodiment

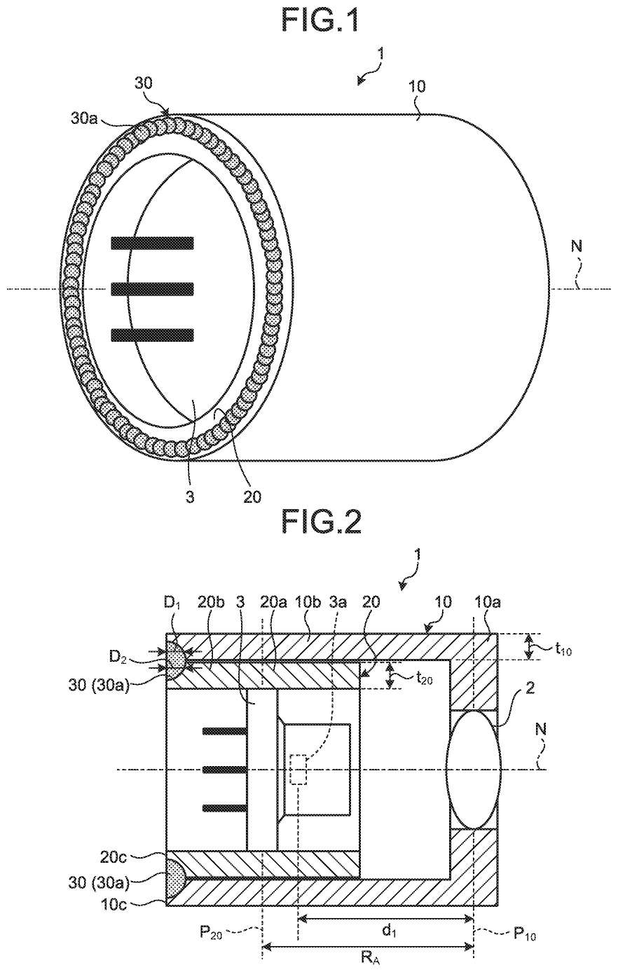

FIG. 1 is a perspective view schematically illustrating a configuration of an optical unit according to a first embodiment. FIG. 2 is a partial cross-sectional view schematically illustrating the configuration of the optical unit according to the first embodiment, and is a partial cross-sectional view taken along a plane including an optical axis N of the optical unit as a section. An optical unit 1 illustrated in the same drawing includes: a lens 2; a substantially cylindrical lens holder 10 that retains the lens 2; a semiconductor laser 3 that has a light source 3a which emits a laser beam in response to an input electric signal; and a cylindrical laser holder 20 that retains the semiconductor laser 3. In FIG. 1, a description will be given assuming that a central axis of the lens holder 10 and a central axis of the laser holder 20 coincide with each other and coincide with the optical axis N of the optical unit 1. The optical unit 1 emits the light emitted from the light source 3a to the outside via the lens 2. In the first embodiment, the lens holder 10 corresponds to a first optical device retaining body, and the laser holder 20 corresponds to a second optical device retaining body. In addition, the lens 2 is a first optical device, and the semiconductor laser 3 is a second optical device.

The lens 2 is configured using a collimator lens or a condenser lens formed using glass or a resin. Incidentally, the lens holder 10 is described as one that retains the single lens 2 in the first embodiment, but the lens holder 10 may retain an optical device constituted by a plurality of lenses.

The lens holder 10 includes: an annular first retaining portion 10a which retains the lens 2; and a cylindrical first fitting margin portion 10b which extends along a direction of the optical axis N toward the semiconductor laser 3 from an end of the first retaining portion 10a in the direction of the optical axis N and is fitted with the laser holder 20. The lens 2 is fixed to the first retaining portion 10a by, for example, soldering or adhesion using an adhesive. Incidentally, a diameter of an inner circumference of the first fitting margin portion 10b is the same as a diameter of an outer circumference of the laser holder 20, and it is sufficient that the diameter of the inner circumference of the first fitting margin portion 10b is a diameter that allows fitting of the laser holder 20.

The laser holder 20 includes: a second retaining portion 20a which retains the semiconductor laser 3; and a cylindrical second fitting margin portion 20b which extends along the direction of the optical axis N toward the side opposite to the lens 2 from an end of the second retaining portion 20a in the direction of the optical axis N and is fitted with the lens holder 10. The semiconductor laser 3 is fixed to the second retaining portion 20a by, for example, laser welding. The diameter of the outer circumference of the second retaining portion 20a is equal to or slightly smaller than the diameter of the inner circumference of the lens holder 10.

It is preferable that the lens holder 10 and the laser holder 20 be configured using a material having the same shrinkage rate when melted and solidified by a laser beam. Examples of such a material include stainless steel (ferrite-based, martensitic-based, and austenitic-based), steel materials (carbon steel for machine structure and rolled steel for general structure), invar materials, and resins (acrylonitrile butadiene styrene (ABS) and poly ether ether ketone (PEEK)). In addition, when the lens holder 10 and the laser holder 20 are fitted in the production of the optical unit 1, surface roughness of the first fitting margin portion 10b and the second fitting margin portion 20b may be reduced in order to easily adjust positions of the lens holder 10 and the laser holder 20, or a gap may be formed by a notch or the like in a part of the fitting portion between the first fitting margin portion 10b and the second fitting margin portion 20b so as to prevent the first fitting margin portion 10b and the second fitting margin portion 20b from coming into contact with each other.

In addition, when a length in a radial direction orthogonal to the direction of the optical axis N of each fitting margin portion is set as a thickness in the first embodiment, a thickness t₁₀ of the first fitting margin portion 10b of the lens holder 10 and a thickness t₂₀ of the second fitting margin portion 20b of the laser holder 20 are the same.

In the optical unit 1, a distance d₁ between the lens 2 and the light source 3a of the semiconductor laser 3 is a distance which satisfies a preset optical condition.

The lens holder 10 and the laser holder 20 are joined as end surfaces 10c and 20c of the first fitting margin portion 10b and the second fitting margin portion 20b intersecting with the direction of the optical axis N are melted and solidified by a laser beam. The end surfaces 10c and 20c form an edge surface portion in which the ends of the first fitting margin portion 10b and the second fitting margin portion 20b in the direction of the optical axis N are aligned. Specifically, the end surfaces 10c and 20c, located in a portion where the first fitting margin portion 10b and the second fitting margin portion 20b overlap each other in the radial direction, the portion being outside a region R_{A} sandwiched by a retaining surface P₁₀ of the first retaining portion 10a and a retaining surface P₂₀ of the second retaining portion 20a in the direction of the optical axis N, are partially joined by melting and solidification by the laser beam. Here, the “retaining surface P₁₀” is a plane which passes through a center of a portion where the first retaining portion 10a comes into contact with the lens 2 in the direction of the optical axis N and is perpendicular to the optical axis N. In addition, the “retaining surface P₂₀” is a plane which passes through a center of a portion where the second retaining portion 20a comes into contact with the semiconductor laser 3 in the direction of the optical axis N and is perpendicular to the optical axis N. With this laser welding, a weld portion 30 is formed on the lens holder 10 and the laser holder 20 as melted portions thereof are mixed and solidified. At this time, the lens 2 and the semiconductor laser 3 are respectively retained by the lens holder 10 and the laser holder 20 on the same side with respect to the weld portion 30 in the optical unit 1. That is, portions of the lens holder 10 and the laser holder 20 which retain the lens 2 and the semiconductor laser 3, respectively and are continuous with the optical devices are located on the same side with respect to the plane passing through the weld portion 30 and orthogonal to the optical axis N. Incidentally, the retaining surface has been described as the surface passing through the center of the portion where the retaining portion comes into contact with the optical device in the direction of the optical axis N, but it is possible to change the design of the passage position such as passage through one end in the direction of the optical axis N of the portion in contact with the optical device.

The weld portion 30 is formed by melting and solidification across the first fitting margin portion 10b and the second fitting margin portion 20b. As illustrated in FIG. 1, the weld portion 30 is formed of a plurality of weld beads 30a provided along a circumferential direction of the optical unit 1. A formation interval of the weld beads 30a corresponds to, for example, a radius of a spot diameter of a laser beam. In addition, when a length in the direction of the optical axis N is set as a depth, and a length in a direction perpendicular to the direction of the optical axis N and a thickness direction of the first fitting margin portion 10b (or the second fitting margin portion 20b) is set as a width in the weld portion 30, a weld depth D₁ at a central portion in the thickness direction of the first fitting margin portion 10b and a weld depth D₂ of the central portion in the thickness direction of the second fitting margin portion 20b are substantially the same. Specifically, the fact that the weld depth D₁ and the weld depth D₂ are substantially the same means that a ratio (D₂/D₁) of the weld depth D₂ of the laser holder 20 relative to the weld depth D₁ of the lens holder 10 irradiated with a laser beam satisfies a relationship of 0.75≤D₂/D₁≤1.25. For example, when the weld depth D₁ is 0.4 mm, the weld depth D₂ is 0.3 to 0.5 mm.

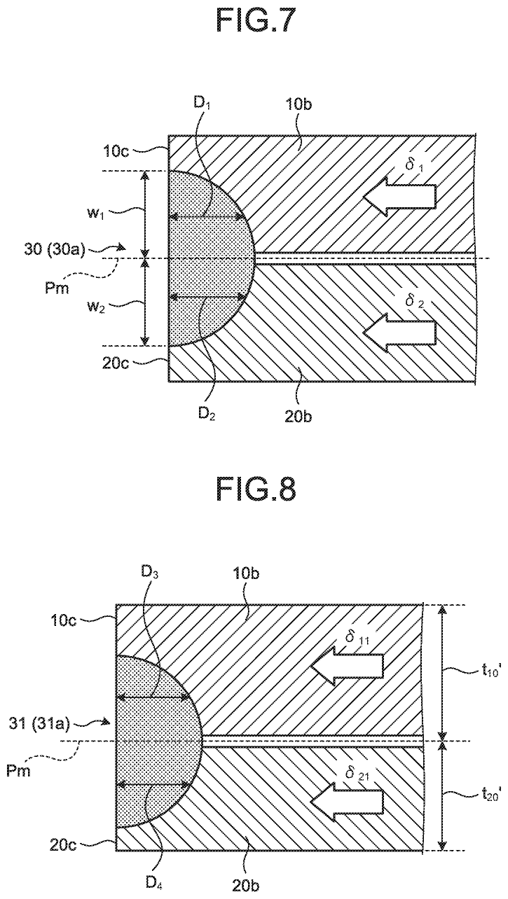

The respective weld beads 30a of the weld portion 30 are preferably symmetric with respect to a mating surface Pm in a cross section (see, for example, FIG. 2) which is perpendicular to the mating surface Pm (see FIG. 7) between the first fitting margin portion 10b and the second fitting margin portion 20b and parallel to the optical axis N. At this time, a weld width w₁ of the first fitting margin portion 10b and a weld width w₂ of the second fitting margin portion 20b (see FIG. 7) are substantially the same. The “mating surface Pm” described herein indicates a plane that passes through a center of a space, formed as the first fitting margin portion 10b and the second fitting margin portion 20b oppose each other, and extends in the direction of the optical axis N. If the first fitting margin portion 10b and the second fitting margin portion 20b come into contact with each other, the mating surface Pm passes through a contact surface between the first fitting margin portion 10b and the second fitting margin portion 20b. In addition, the expression, “substantially the same” described herein indicates that a difference between the weld width of the first fitting margin portion 10b and the weld width of the second fitting margin portion 20b is 100 μm or smaller. Incidentally, even when the weld beads 30a viewed from the direction of the optical axis N do not have regular shapes, such as a perfect circle or an ellipse, but have irregular shapes, some of the weld beads 30a are preferably symmetric with respect to the mating surface Pm.

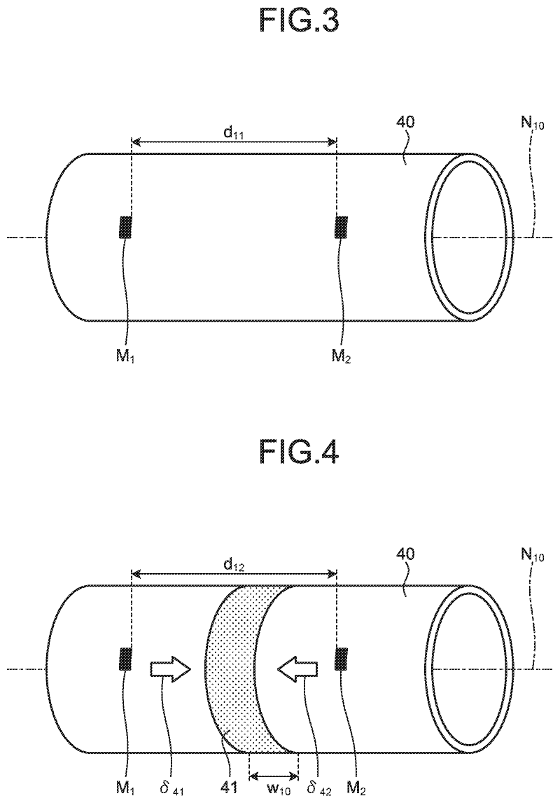

Next, shrinkage of a holder caused by melting and solidification will be described with reference to FIGS. 3 and 4. FIGS. 3 and 4 are views for describing a method for measuring a dimensional change at the time of melting and solidification.

First, two markers M₁ and M₂ are applied to an outer surface of a cylindrical member for measurement (hereinafter, referred to as a measurement member) 40 (see FIG. 3). The markers M₁ and M₂ may be made using an ink or a sealing material. The markers M₁ and M₂ are preferably provided along a direction of an optical axis N₁₀ of the measurement member 40.

Thereafter, a distance d₁₁ between the markers M₁ and M₂ is measured. The distance d₁₁ is a distance between the marker M₁ and the marker M₂ in the direction of the optical axis N₁₀.

After the distance d₁₁ between the markers M₁ and M₂ before melting and solidification is measured, a part of a space between the markers M₁ and M₂ is irradiated with a laser beam to melt and solidify a part of the measurement member 40. At this time, the entire circumference of the measurement member 40 is irradiated with the laser beam as illustrated in FIG. 4. For example, the laser beam is emitted while the measurement member 40 is rotated about the optical axis N₁₀ or a laser head that emits the laser beam is rotated along the outer circumference of the measurement member 40. As a result, a weld portion 41 which circles the optical axis N₁₀ is formed on the measurement member 40. Due to the formation of the weld portion 41, the measurement member 40 shrinks in directions (arrows δ₄₁ and δ₄₂ in FIG. 4) in which both ends approach each other with the weld portion 41 as a boundary.

After the weld portion 41 is formed on the measurement member 40, a distance d₁₂ between the marker M₁ and the marker M₂ is measured. The distance d₁₂ is smaller than the above-described distance d₁₁ due to the shrinkage of the measurement member 40 caused by melting and solidification. A difference between the distance d₁₁ and the distance d₁₂ is calculated as a dimensional change amount (shrinkage amount). Thereafter, the intensity of the laser beam is changed to form the weld portion 41 having a weld width w₁₀ as described above, and the dimensional change amount caused by the shrinkage is measured. Since the intensity of the laser beam is changed, the dimensional change amount for the different weld widths may be obtained.

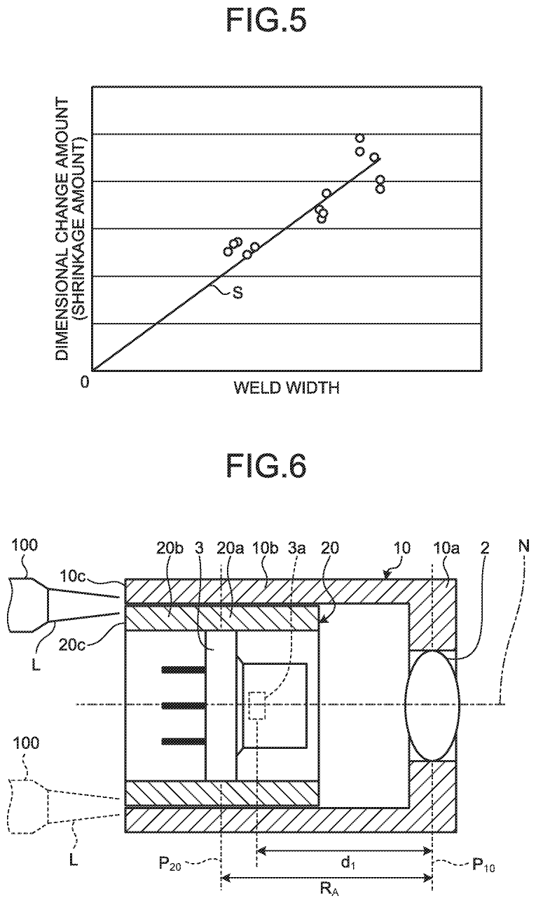

FIG. 5 is a view for describing an example of a measurement result of the dimensional change at the time of melting and solidification, and is a view illustrating a relationship between the weld width and the dimensional change amount. As illustrated in FIG. 5, the weld width and the dimensional change amount are substantially proportional (see an approximate straight line S in FIG. 5). As a result, it is possible to easily predict that a change in a positional relationship between the lens 2 and the semiconductor laser 3 before the melting and solidification increases as the difference between the weld width of the lens holder 10 and the weld width of the laser holder 20 increases in the weld portion 30. Incidentally, the relationship of the weld width is the same as the relationship of the weld depth described above. Hereinafter, a description will be sometimes given by replacing the relationship of the weld width with the relationship of the weld depth.

Next, a method for producing the above-described optical unit 1 will be described with reference to FIG. 6. FIG. 6 is a schematic view illustrating production of the optical unit according to the first embodiment.

First, the laser holder 20 is inserted into and fitted to the inside of the first fitting margin portion 10b from the second retaining portion 20a side. Thereafter, the laser holder 20 is moved relative to the lens holder 10 such that the distance d₁ between the lens 2 and the light source 3a becomes the distance satisfying the optical condition, thereby adjusting an optical path length between the lens 2 and the semiconductor laser 3. The optical unit 1 according to the present disclosure is, for example, a compact optical unit which has an adjustment margin range of an optical path between 20 μm and 50 μm and in which the optical path length is adjusted in units of submicron to several microns.

Thereafter, a laser head 100 is arranged to irradiate the edge surface portion, formed of the end surface 10c of the lens holder 10 and the end surface 20c of the laser holder 20, with a laser beam L, thereby melting and solidifying a part of the lens holder 10 and a part of the laser holder 20. The laser beam L at this time is emitted to the end surface 10c and the end surface 20c located at a position where the first fitting margin portion 10b and the second fitting margin portion 20b overlap each other in the radial direction, outside the region R_{A} in the direction of the optical axis N. In addition, the intensity distribution of the laser beam L or movement of the laser head 100 is used to melt and solidify the lens holder 10 and the laser holder 20 such that the weld depths in the respective holders are substantially the same. At this time, the laser beam L may be intermittently emitted using pulsed light or may be continuously emitted. In the case where the weld portion 30 is intermittently irradiated with the laser beam, the weld beads 30a may be formed intermittently along the circumferential direction of the holder, or the weld beads 30a may be continuously connected over the entire region in the circumferential direction. In addition, the weld portion 30 is formed of one weld bead extending in the circumferential direction in the case of being formed by the laser beam emitted continuously instead of pulse oscillation.

As the laser beam L, for example, a laser beam having generally known Gaussian intensity distribution may be used. In addition, a laser beam having top-hat intensity distribution in which values of a beam diameter at the lower limit intensity at which the holder may be melted and a beam diameter at the peak intensity may be substantially the same and the beam intensity rises sharply from an edge of the beam toward the center to reach the peak intensity may be used.

FIG. 7 is a view for describing shrinkage of each holder when laser welding is performed. The lens holder 10 and the laser holder 20 shrink due to the formation of the weld portion 30 (the weld bead 30a) (see a block arrow in FIG. 7). In the first embodiment, the end surface 10c and the end surface 20c located outside the region R_{A} are welded, and thus, moving directions of the lens 2 and the semiconductor laser 3 due to the shrinkage become the same. For example, when a shrinkage amount caused by welding of the lens holder 10 is denoted by δ₁ and a shrinkage amount of the laser holder 20 is denoted by δ₂, these shrinkage amounts δ₁ and δ₂ are defined depending on the weld depths D₁ and D₂ of the respective holders. At this time, the shrinkage amounts δ₁ and δ₂ become the same as described with reference to FIG. 5 when the weld depths D₁ and D₂ are the same.

In the first embodiment described above, the lens holder 10 and the laser holder 20 are joined by forming the weld portion 30 in which the weld depth D₁ of the lens holder 10 and the weld depth D₂ of the laser holder 20 are substantially the same in the end surfaces 10c and 20c in which the first fitting margin portion 10b and the second fitting margin portion 20b overlap each other and which are located outside the region R_{A} sandwiched between the retaining surface P₁₀ of the first retaining portion 10a and the retaining surface P₂₀ of the second retaining portion 20a. As a result, when laser welding is performed, the respective holders shrink by the same shrinkage amount, and the lens 2 and the semiconductor laser 3 move to the same side. As a result, even if shrinkage occurs due to melting and solidification, the lens holder 10 and the laser holder 20 may be welded while suppressing a relative positional deviation between the optical devices retained by the respective holders. In this manner, it is possible to obtain the optical unit having desired optical characteristics even when the holders are joined by welding according to the first embodiment.

### First Modification of First Embodiment

FIG. 8 is a cross-sectional view schematically illustrating a configuration of a main part of an optical unit according to a first modification of the first embodiment. Although the description has been given assuming that the thickness t₁₀ of the first fitting margin portion 10b and the thickness t₂₀ of the second fitting margin portion 20b are the same in the first embodiment described above, there is also a case where the thicknesses are different. A case where a thickness t₁₀′ of the first fitting margin portion 10b and a thickness t₂₀′ of the second fitting margin portion 20b are different (t₁₀′>t₂₀′) will be described in the first modification.

In the first modification, a weld portion 31 is formed in an overlapping portion between the first fitting margin portion 10b and the second fitting margin portion 20b on the end surfaces 10c and 20c (the edge surface portion) located in the outer side of the above-described region R_{A} with respect to the first fitting margin portion 10b and the second fitting margin portion 20b having different thicknesses, thereby joining the lens holder 10 and the laser holder 20. This weld portion 31 is formed of the plurality of weld beads 31a similarly to the first embodiment described above. At this time, if a weld depth D₃ at a central portion in the thickness direction of the lens holder 10 and a weld depth D₄ at a central portion in the thickness direction of the laser holder 20 are substantially the same in the weld portion 31, a shrinkage amount V of the lens holder 10 in the direction of the optical axis N and a shrinkage amount δ₂₁ of the laser holder 20 in the direction of the optical axis N are the same. As a result, an optical path length of an optical device may be maintained even when each holder shrinks due to welding.

Even in the first modification, the respective weld beads 31a of the weld portion 31 are preferably symmetric with respect to the mating surface Pm similarly to the first embodiment.

### Second Modification of First Embodiment

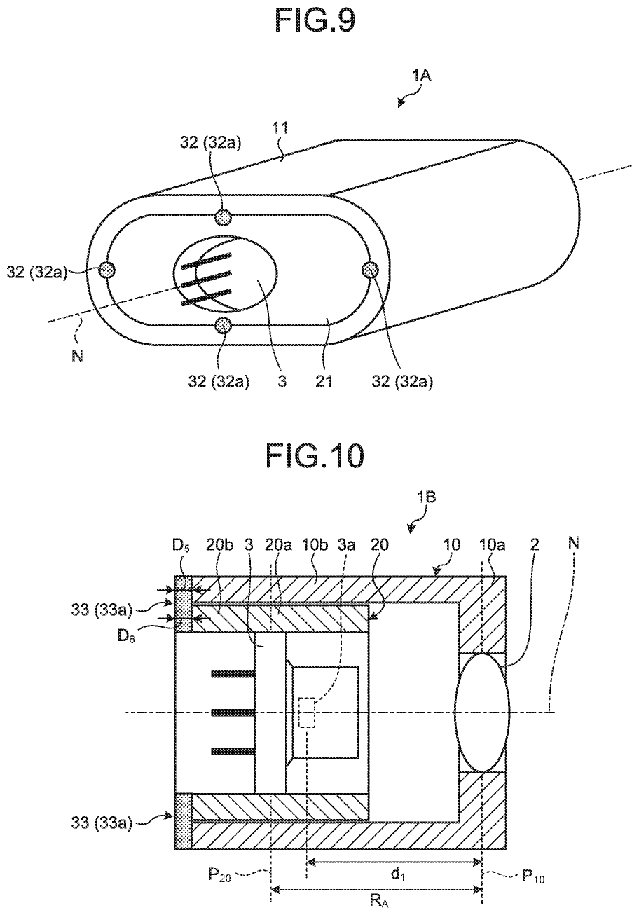

FIG. 9 is a perspective view schematically illustrating a configuration of an optical unit according to a second modification of the first embodiment. Although the description has been given assuming that a shape of an outer circumference of the optical unit 1 viewed from the direction of the optical axis N, that is, a shape of an outer circumference of the lens holder 10 is a circle in the first embodiment described above, but the shape is not limited to the circle. In the second modification, the shape of the outer circumference of the optical unit 1 viewed from the direction of the optical axis N, that is, the shape of the outer circumference of the lens holder 10 is a rounded square. The “rounded square” described herein indicates a shape of the square arc corners.

An optical unit 1A illustrated in FIG. 9 includes: the above-described lens 2 (not illustrated); a substantially cylindrical lens holder 11 that retains the lens 2; the semiconductor laser 3 that has the light source 3a (not illustrated) which emits a laser beam in response to an input electric signal; and a cylindrical laser holder 21 that retains the semiconductor laser 3. In the second modification, the lens holder 11 corresponds to a first optical device retaining body, and the laser holder 21 corresponds to a second optical device retaining body.

The lens holder 11 includes: an annular first retaining portion which retains the lens 2; and a cylindrical first fitting margin portion which extends along a direction of the optical axis N toward the semiconductor laser 3 from an end of the first retaining portion in the direction of the optical axis N and is fitted with the laser holder 21. An outer circumference of the lens holder 11 forms a rounded square.

The laser holder 21 includes: a second retaining portion which retains the semiconductor laser 3; and a cylindrical second fitting margin portion which extends along the direction of the optical axis N toward the side opposite to the lens 2 from an end of the second retaining portion in the direction of the optical axis N and is fitted with the lens holder 11. The semiconductor laser 3 is fixed to the second retaining portion by, for example, laser welding.

In the optical unit 1A, a weld portion 32 is formed in an overlapping portion between the lens holder 11 and the laser holder 21 on end surface located outside the above-described region R_{A} (for example, see FIG. 2), thereby joining the lens holder 11 and the laser holder 21. The weld portion 32 is formed of a plurality of weld beads 32a, and a weld depth at a central portion in the thickness direction of the lens holder 11 and a weld depth at the central portion in the thickness direction of the laser holder 21 are substantially the same. The weld beads 32a are provided at places where the circumferential direction is equally divided into four, but may be provided so as to overlap each other in the circumferential direction similarly to the first embodiment.

When welding is performed to satisfy conditions of the weld position, the weld depth, and the weld width as in the second modification, it is possible to apply the disclosure even if the shape of the outer circumference viewed from the direction of the optical axis N is a shape other than the circle described in the above first embodiment described above.

In addition, each holder may be a rounded square different from that the circle as the shape viewed in the direction of the optical axis N as in the second modification, or may be an ellipse or a polygon. It is sufficient for each holder to have a sleeve shape capable of retaining an optical device.

### Third Modification of First Embodiment

FIG. 10 is a partial cross-sectional view schematically illustrating a configuration of an optical unit according to a third modification of the first embodiment. In the third modification, a weld portion 33 is formed by melting and solidifying all the end surface 10c of the lens holder 10 and the end surface 20c of the laser holder 20 described above.

An optical unit 1B illustrated in FIG. 10 includes the lens 2, the lens holder 10, the semiconductor laser 3, and the laser holder 20 described above. In the optical unit 1B, the weld portion 33 is formed in an overlapping portion between the lens holder 10 and the laser holder 20 on end surface located outside the above-described region R_{A}, thereby joining the lens holder 10 and the laser holder 20.

The weld portion 33 is formed of a plurality of weld beads 33a, and a weld depth D₅ at a central portion in the thickness direction of the lens holder 10 and the weld depth D₆ at a central portion in the thickness direction of the laser holder 20 are substantially the same. In addition, the respective weld beads 33a are provided over the entire region in the thickness direction on the ends of the lens holder 10 and the laser holder 20. The weld bead 33a is formed, for example, by irradiation of a laser beam having the same spot diameter as a thickness of a fitting margin portion of each holder or by irradiation performed by inclining an optical axis of a laser beam having the spot diameter with respect to the optical axis N.

If the weld depths of the respective holders are substantially the same in the case of forming the weld portion formed over the entire region in the thickness direction of the fitting margin portion of the holder as in the third modification, an optical path length of the optical device may be maintained even when the respective holders shrink due to welding.

### Fourth Modification of First Embodiment

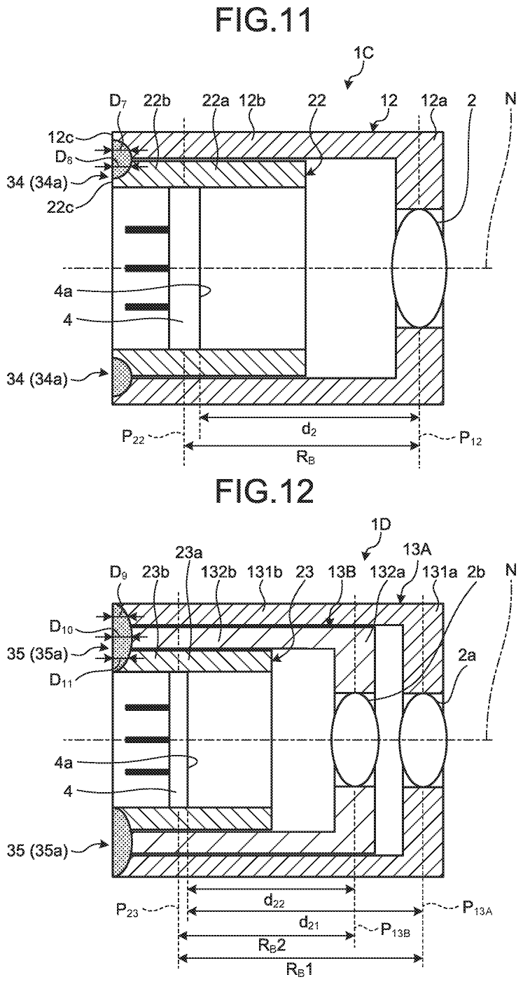

FIG. 11 is a partial cross-sectional view schematically illustrating a configuration of an optical unit according to a fourth modification of the first embodiment. Although the description has been given assuming that the second optical device is the semiconductor laser 3 in the first embodiment described above, an image sensor 4 is used as the second optical device in the present modification. An optical unit 1C according to the present modification is provided, for example, at a distal end of a scope such as an endoscope including an insertion portion to be inserted into a subject.

The optical unit 1C illustrated in FIG. 11 includes: the lens 2; a substantially cylindrical lens holder 12 which retains the lens 2; the image sensor 4 which has a light receiving surface 4a to receive light from the outside, and converts the received light into an electric signal; and a cylindrical sensor holder 22 which retains the image sensor 4. In FIG. 11, a description will be given assuming that a central axis of the lens holder 12 and a central axis of the sensor holder 22 coincide with each other and coincide with the optical axis N of the optical unit 1C. The lens 2 is a lens configured to form an image of light from the outside on the light receiving surface 4a. In the fourth modification, the lens holder 12 corresponds to a first optical device retaining body, and the sensor holder 22 corresponds to a second optical device retaining body. In addition, the image sensor 4 is a second optical device in the fourth modification.

In the lens holder 12, a diameter of an inner circumferential surface, the diameter in a direction orthogonal to the optical axis N is substantially equal to a diameter of an outer circumference of the sensor holder 22. The lens holder 12 includes: an annular first retaining portion 12a which retains the lens 2; and a cylindrical first fitting margin portion 12b which extends along the direction of the optical axis N toward the image sensor 4 from an end of the first retaining portion 12a in the direction of the optical axis N and is fitted with the sensor holder 22. The lens 2 is fixed to the first retaining portion 12a by, for example, soldering or adhesion using an adhesive. Incidentally, the diameter of the inner circumferential surface of the lens holder 12 is the same as the diameter of the outer circumference of the sensor holder 22, but it is sufficient that the diameter of the inner circumferential surface of the lens holder 12 is a diameter that allows fitting of the sensor holder 22.

The sensor holder 22 includes: a second retaining portion 22a which retains the image sensor 4; and a cylindrical second fitting margin portion 22b which extends along the direction of the optical axis N toward a side opposite to the lens 2 from an end of the second retaining portion 22a in the direction of the optical axis N and is fitted with the lens holder 12. The image sensor 4 is fixed to the second retaining portion 22a by, for example, laser welding. The diameter of the outer circumference of the sensor holder 22 is equal to or slightly smaller than the diameter of the inner circumference of the lens holder 12.

The image sensor 4 is implemented using, for example, a charge coupled device (CCD) image sensor or a complementary metal oxide semiconductor (CMOS) image sensor. The image sensor 4 photoelectrically converts received observation light to generate an electric signal.

In the optical unit 1C, a distance d₂ between the lens 2 and the light receiving surface 4a of the image sensor 4 is a distance that satisfies a preset optical condition.

In addition, the lens holder 12 and the sensor holder 22 are joined by melting and solidification, using a laser beam, of a portion where the first fitting margin portion 12b and the second fitting margin portion 22b overlap each other in the radial direction, the portion being outside a region R_{B} sandwiched between a retaining surface P₁₂ of the first retaining portion 12a and a retaining surface P₂₂ of the second retaining portion 22a in the direction of the optical axis N. Here, the “retaining surface P₁₂” is a plane which passes through a center of a portion where the first retaining portion 12a comes into contact with the lens 2 in the direction of the optical axis N and is perpendicular to the optical axis N. In addition, the “retaining surface P₂₂” is a plane which passes through a center of a portion where the second retaining portion 22a comes into contact with the image sensor 4 in the direction of the optical axis N and is perpendicular to the optical axis N. With this laser welding, a weld portion 34 is formed on the lens holder 12 and the sensor holder 22 as melted portions thereof are mixed and solidified. In addition, the lens 2 and the image sensor 4 are respectively retained by the lens holder 12 and the sensor holder 22 on the same side with respect to the weld portion 34 in the optical unit 1C. The weld portion 34 is formed of a plurality of weld beads 34a, and a weld depth D₇ at a central portion in the thickness direction of the lens holder 12 and a weld depth D₈ at a central portion in the thickness direction of the sensor holder 22 are substantially the same, which is similar to the weld portion 30 described above.

The optical unit 1C is produced in the same manner as the optical unit 1 described above. Specifically, the sensor holder 22 is inserted into and fitted to the inside of the first fitting margin portion 12b from the second retaining portion 22a side. At this time, the sensor holder 22 is moved relative to the lens holder 12 to adjust an optical path length between the lens 2 and the image sensor 4 such that the distance d₂ between the lens 2 and the light receiving surface 4a becomes the distance that satisfies the optical condition. Thereafter, end surfaces of the lens holder 12 and the sensor holder 22, that is, end surfaces 12c and 22c (an edge surface portion) located outside the above-described region R_{B} are irradiated with a laser beam to melt and solidify a part of the first fitting margin portion 12b and a part of the second fitting margin portion 22b.

In the fourth modification of the first embodiment described above, the lens holder 12 and the sensor holder 22 are joined by forming the weld portion 34 in which the weld depth D₇ of the lens holder 12 and the weld depth D₈ of the sensor holder 22 are substantially the same outside the region R_{B} in which the first fitting margin portion 12b and the second fitting margin portion 22b overlap each other and which is sandwiched between the retaining surface P₁₂ of the first retaining portion 12a and the retaining surface P₂₂ of the second retaining portion 22a, which is similar to the first embodiment. As a result, shrinkage amounts of the lens holder 12 and the sensor holder 22 at the time of laser welding are the same, and moving directions of the optical devices retained by the respective holders are the same. As a result, it is possible to weld the lens holder 12 and the sensor holder 22 while suppressing a relative positional deviation between the optical devices retained by the respective holders even if shrinkage occurs due to melting and solidification. In this manner, it is possible to obtain the optical unit having desired optical characteristics even when the holders are joined by welding according to the fourth modification of the first embodiment.

Incidentally, the description has been given assuming that the second optical device is the image sensor in the fourth modification described above, the second optical device may include not only an image sensor but also an electronic component, which is provided separately from the image sensor, such as a digital signal processor (DSP) that performs compression and filtering, and processes an electrical signal acquired by the image sensor.

### Second Embodiment

FIG. 12 is a cross-sectional view schematically illustrating a configuration of an optical unit according to a second embodiment, and is a partial cross-sectional view taken along a plane including the optical axis N of the optical unit as a section. In the second embodiment, an optical unit 1D includes two lens holders that retain different lenses, respectively.

The optical unit 1D illustrated in FIG. 12 includes: two lenses (lenses 2a and 2b); two substantially cylindrical lens holders (a first lens holder 13A and a second lens holder 13B) which retain the respective lenses; the image sensor 4 described above, and a cylindrical sensor holder 23 which retains the image sensor 4. In FIG. 12, a description will be given assuming that central axes the first lens holder 13A and the second lens holder 13B and a central axis of the sensor holder 23 coincide with each other and coincide with the optical axis N of the optical unit 1D. Incidentally, when the second lens holder 13B is used as a first optical device retaining body among the first lens holder 13A, the second lens holder 13B, and the sensor holder 23, the first lens holder 13A and the sensor holder 23 serve as second optical device retaining bodies. In addition, the two lenses (lenses 2a and 2b) correspond to first optical devices.

The first lens holder 13A includes: an annular first retaining portion 131a which retains the lens 2a; and a first fitting margin portion 131b which extends along the direction of the optical axis N toward the image sensor 4 from an end of the first retaining portion 131a in the direction of the optical axis N and is fitted with the second lens holder 13B. The lens 2a is fixed to the first retaining portion 131a by, for example, soldering or adhesion using an adhesive.

The second lens holder 13B includes: an annular first retaining portion 132a which retains the lens 2b; and a first fitting margin portion 132b which extends along the direction of the optical axis N toward the image sensor 4 from an end of the first retaining portion 132a in the direction of the optical axis N and is fitted with each of the first lens holder 13A and the sensor holder 23. A diameter of an outer circumference of the second lens holder 13B is substantially equal to a diameter of an inner circumference of the first lens holder 13A, and it is sufficient that the diameter of the outer circumference of the second lens holder 13B is a diameter that allows fitting into the first lens holder 13A. The lens 2b is fixed to the first retaining portion 132a by, for example, soldering or adhesion using an adhesive.

The sensor holder 23 includes: an annular second retaining portion 23a which retains the image sensor 4; and a second fitting margin portion 23b which extends along the direction of the optical axis N toward a side opposite to the lens 2a from an end of the second retaining portion 23a in the direction of the optical axis N and is fitted with the second lens holder 13B. A diameter of an outer circumference of the sensor holder 23 is substantially equal to a diameter of an inner circumference of the second lens holder 13B, and it is sufficient that the diameter of the outer circumference of the sensor holder 23 is a diameter that allows fitting to the inside of the second lens holder 13B. The image sensor 4 is fixed to the second retaining portion 23a by, for example, laser welding.

In the optical unit 1D, the second lens holder 13B is fixed in the state of being inserted into the first fitting margin portion 131b of the first lens holder 13A from the first retaining portion 132a side. In addition, the sensor holder 23 is fixed in the state of being inserted into the first fitting margin portion 132b of the second lens holder 13B from the second retaining portion 23a side.

In the optical unit 1D, a distance d₂₁ between the lens 2a and the light receiving surface 4a of the image sensor 4 and a distance d₂₂ between the lens 2b and the light receiving surface 4a are distances that satisfy preset optical conditions.

The first lens holder 13A, the second lens holder 13B, and the sensor holder 23 are joined by melting and solidification using a laser beam in a region where all the holders overlap each other along a direction orthogonal to the direction of the optical axis N. Specifically, in the first lens holder 13A, the second lens holder 13B, and the sensor holder 23, end surfaces are joined by melting and solidification using a laser beam, the end surfaces being located in a portion where the first fitting margin portion 131b, the first fitting margin portion 132b, and the second fitting margin portion 23b overlap each other in the radial direction, a portion outside a region R_{B}1 sandwiched between a retaining surface P_{13A} of the first retaining portion 131a and a retaining surface P₂₃ of the second retaining portion 23a in the direction of the optical axis N and a portion outside a region R_{B}2 sandwiched between a retaining surface P_{13B} of the first retaining portion 132a and the retaining surface P₂₃ of the second retaining portion 23a in the direction of the optical axis N. Here, the “retaining surface P_{13A}” is a plane which passes through a center of a portion where the first retaining portion 131a comes into contact with the lens 2a in the direction of the optical axis N and is perpendicular to the optical axis N. In addition, the “retaining surface P_{13B}” is a plane which passes through a center of a portion where the first retaining portion 132a comes into contact with the lens 2b in the direction of the optical axis N and is perpendicular to the optical axis N. In addition, the “retaining surface P₂₃” is a plane which passes through a center of a portion where the second retaining portion 23a comes into contact with the image sensor 4 in the direction of the optical axis N and is perpendicular to the optical axis N. With this laser welding, a weld portion 35 is formed on the first lens holder 13A, the second lens holder 13B, and the sensor holder 23 as melted portions thereof are mixed and solidified. In addition, the lenses 2a and 2b and the image sensor 4 are respectively retained by the first lens holder 13A, the second lens holder 13B, and the sensor holder 23 on the same side with respect to the weld portion 35. The weld portion 35 is formed of a plurality of weld beads 35a, and a weld depth D₉ at a central portion in the thickness direction of the first lens holder 13A, a weld depth D₁₀ at a central portion in the thickness direction of the second lens holder 13B, and a weld depth D₁₁ at a central portion in the thickness direction of the sensor holder 23 are substantially the same.

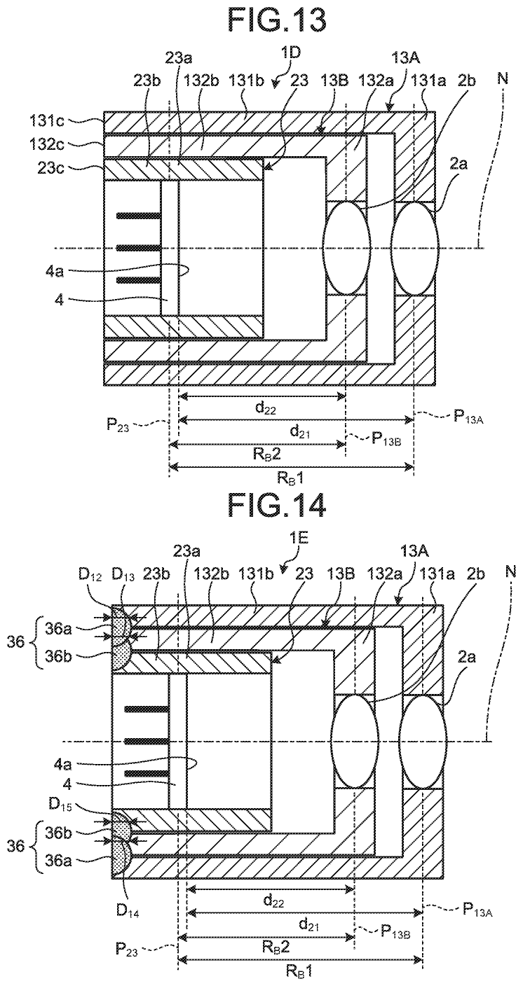

FIG. 13 is a partial cross-sectional view for describing production of the optical unit according to the second embodiment. When producing the optical unit 1D, first, the second lens holder 13B is inserted into and fitted to the inside of the first fitting margin portion 131b from the first retaining portion 132a side. Thereafter, the sensor holder 23 is inserted into and fitted to the inside of the first fitting margin portion 132b from the second retaining portion 23a side. At this time, optical path lengths among the respective optical devices of the first lens holder 13A, the second lens holder 13B, and the sensor holder 23 are adjusted such that the distance d₂₁ between the lens 2a and the light receiving surface 4a and the distance d₂₂ between the lens 2b and the light receiving surface 4a become the distances that satisfy the optical conditions. Thereafter, an edge surface portion including an end surface 131c of the first lens holder 13A, an end surface 132c of the second lens holder 13B, and an end surface 23c of the sensor holder 23 is irradiated with a laser beam to melt and solidify a part of the first lens holder 13A, a part of the second lens holder 13B, and a part of the sensor holder 23.

In the second embodiment described above, the weld portion 35 having the same weld depths are formed by emitting the laser beam to the end surfaces located in the portion where all the first lens holder 13A, the second lens holder 13B, and the sensor holder 23 overlap each other in the radial direction orthogonal to the direction of the optical axis N, the portion outside the regions each of which is sandwiched between the retaining surface of the retaining portion that retains the device on one end and the retaining surface of the retaining portion that retains the device on the other end in the direction of the optical axis N, thereby joining the holders. As a result, shrinkage amounts and moving directions of the holder to be joined at the time of laser welding become the same. As a result, it is possible to weld the first lens holder 13A, the second lens holder 13B, and the sensor holder 23 while suppressing relative positional deviations among the optical devices retained by the respective holders even if shrinkage occurs due to melting and solidification. In this manner, it is possible to obtain the optical unit having desired optical characteristics even when the holders are joined by welding according to the second embodiment.

### Modification of Second Embodiment

FIG. 14 is a partial cross-sectional view schematically illustrating a configuration of an optical unit according to a modification of the second embodiment, and is a partial cross-sectional view taken along a plane including an optical axis of the optical unit as a section. Although the description has been given assuming that the single weld bead 35a collectively joins the plurality of holders in the weld portion 35 in the second embodiment described above, a weld portion 36 according to the present modification is formed of a plurality of weld bead groups each having a set of partial weld beads to join adjacent holders.

An optical unit 1E illustrated in FIG. 14 includes the lenses 2a and 2b, the first lens holder 13A, the second lens holder 13B, the image sensor 4, and the sensor holder 23 described above. In the first lens holder 13A, the second lens holder 13B, and the sensor holder 23, end surfaces are joined by melting and solidification using a laser beam, the end surfaces being located in a portion where the first fitting margin portion 131b, the first fitting margin portion 132b, and the second fitting margin portion 23b overlap each other in the radial direction, a portion outside the region R_{B}1 sandwiched between the retaining surface P_{13A} of the first retaining portion 131a and the retaining surface P₂₃ of the second retaining portion 23a in the direction of the optical axis N and a portion outside the region R_{B}2 sandwiched between the retaining surface P_{13B} of the first retaining portion 132a and the retaining surface P₂₃ of the second retaining portion 23a in the direction of the optical axis N, which is similar to the second embodiment. With this laser welding, the weld portion 36 is formed on the first lens holder 13A, the second lens holder 13B, and the sensor holder 23 as melted portions thereof are mixed and solidified. In addition, the lenses 2a and 2b and the image sensor 4 are respectively retained by the first lens holder 13A, the second lens holder 13B, and the sensor holder 23 on the same side with respect to the weld portion 36.

The weld portion 36 is formed of the plurality of weld bead groups each having a set of partial weld beads 36a and 36b for respectively joining holders adjacent in the radial direction. The partial weld bead 36a joins the first lens holder 13A and the second lens holder 13B. The partial weld bead 36b joins the second lens holder 13B and the sensor holder 23. In the weld portion 36, a weld depth D₁₂ at a central portion in the thickness direction of the first lens holder 13A in the partial weld bead 36a, a weld depth D₁₃ at a central portion in the thickness direction of the second lens holder 13B in the partial weld bead 36a, a weld depth D₁₄ at a central portion in the thickness direction of the second lens holder 13B in the partial weld bead 36b, and a weld depth D₁₅ at a central portion in the thickness direction of the sensor holder 23 in the partial weld bead 36b are substantially the same.

If the weld depths of the respective holders are substantially the same even in the case of the configuration in which the joining is performed using the partial weld bead joining the holders adjacent in the radial direction as in the present modification, an optical path length of the optical device may be maintained even when the respective holders shrink due to welding.

### Third Embodiment

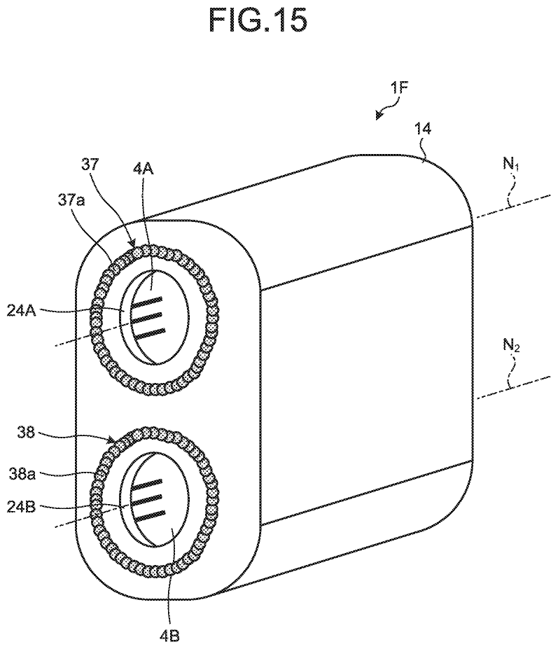

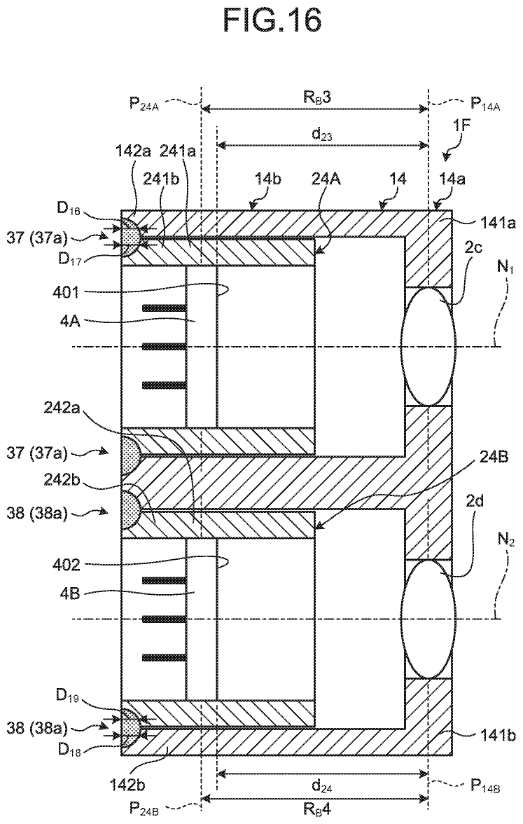

FIG. 15 is a perspective view schematically illustrating a configuration of an optical unit according to a third embodiment. FIG. 16 is a partial cross-sectional view schematically illustrating the configuration of the optical unit according to the third embodiment, and is a partial cross-sectional view taken along a plane including an optical axis of the optical unit as a section. In the third embodiment, an optical unit 1F includes two lens holders that retain different lenses, respectively.

The optical unit 1F illustrated in FIGS. 15 and 16 includes: two lenses (lenses 2c and 2d); a substantially cylindrical lens holder 14 which retains the respective lens; two image sensors (image sensors 4A and 4B) which convert received light into electric signals; and two cylindrical sensor holders (a first sensor holder 24A and a second sensor holder 24B) which retain the image sensors 4A and 4B, respectively. In the third embodiment, a description will be given assuming that an optical axis of the lens 2c retained by the lens holder 14 and an axis passing through a center of a light receiving surface 401 of the first sensor holder 24A coincide with each other and coincide with an optical axis N₁ of the optical unit 1F. In addition, a description will be given assuming that an optical axis of the lens 2d retained by the lens holder 14 and an axis passing through a center of a light receiving surface 402 of the second sensor holder 24B coincide with each other and coincide with an optical axis N₂ of the optical unit 1F. A description will be given assuming that the optical axis N₁ and the optical axis N₂ are parallel. Incidentally, when the lens holder 14 is used as a first optical device retaining body among the lens holder 14, the first sensor holder 24A, and the second sensor holder 24B, the first sensor holder 24A and the second sensor holder 24B serve as second optical device retaining bodies. In addition, the two lenses (lenses 2c and 2d) correspond to first optical devices, and the two image sensors (image sensors 4A and 4B) correspond to second optical devices.

The lens holder 14 includes: a first retaining portion 14a which retains the lenses 2c and 2d; and a first fitting margin portion 14b which extends along a direction of the optical axis N₁ (or a direction of the optical axis N₂) toward the image sensors 4A and 4B from an end of the first retaining portion 14a in the direction of the optical axis N₁ (or the direction of the optical axis N₂) and is fitted with each of the first sensor holder 24A and the second sensor holder 24B.

The first retaining portion 14a includes a first lens retaining portion 141a which retains the lens 2c and a second lens retaining portion 141b which retains the lens 2d. The lens 2c is fixed to the first lens retaining portion 141a by, for example, soldering or adhesion using an adhesive. The lens 2d is fixed to the second lens retaining portion 141b by, for example, soldering or adhesion using an adhesive.

The first fitting margin portion 14b includes: a first holder fitting margin portion 142a fitted with the first sensor holder 24A; and a second holder fitting margin portion 142b fitted with the second sensor holder 24B.

The first sensor holder 24A includes: an annular second retaining portion 241a which retains the image sensor 4A; and a second fitting margin portion 241b which extends along the direction of the optical axis N₁ toward a side opposite to the lens 2c from an end of the second retaining portion 241a in the direction of the optical axis N₁ and is fitted with the first holder fitting margin portion 142a. A diameter of an outer circumference of the first sensor holder 24A is substantially equal to a diameter of an inner circumference of the first holder fitting margin portion 142a of the lens holder 14, and it is sufficient that the diameter of the outer circumference of the first sensor holder 24A is a diameter that allows fitting to the inside of the first holder fitting margin portion 142a. The image sensor 4A is fixed to the second retaining portion 241a by, for example, laser welding.

The second sensor holder 24B includes: an annular second retaining portion 242a which retains the image sensor 4B; and a second fitting margin portion 242b which extends along the direction of the optical axis N₂ toward a side opposite to the lens 2d from an end of the second retaining portion 242a in the direction of the optical axis N₂ and is fitted with the second holder fitting margin portion 142b. A diameter of an outer circumference of the second sensor holder 24B is substantially equal to a diameter of an inner circumference of the second holder fitting margin portion 142b of the lens holder 14, and it is sufficient that the diameter of the outer circumference of the second sensor holder 24B is a diameter that allows fitting to the inside of the second holder fitting margin portion 142b. The image sensor 4B is fixed to the second retaining portion 242a by, for example, laser welding.

In the optical unit 1F, the first sensor holder 24A is fixed in the state of being inserted into the first holder fitting margin portion 142a of the lens holder 14 from the second retaining portion 241a side. In addition, the second sensor holder 24B is fixed in the state of being inserted into the second holder fitting margin portion 142b of the lens holder 14 from the second retaining portion 242a side.

In the optical unit 1F, a distance d₂₃ between the lens 2c and the light receiving surface 401 of the image sensor 4A and a distance d₂₄ between the lens 2d and the light receiving surface 402 of the image sensor 4B are distances that satisfy preset optical conditions.

The lens holder 14, the first sensor holder 24A, and the second sensor holder 24B are joined by melting and solidification using a laser beam in a region where the holders to be joined overlap each other along a direction orthogonal to the directions of the optical axes (the optical axis N₁ and the optical axis N₂).

Specifically, the lens holder 14 and the first sensor holder 24A are joined by melting and solidification, using a laser beam, of end surfaces located in a portion where the first holder fitting margin portion 142a and the second fitting margin portion 241b overlap each other in the radial direction, the portion being outside a region R_{B}3 sandwiched by a retaining surface P_{14A} of the first lens retaining portion 141a and a retaining surface P_{24A} of the second retaining portion 241a in the direction of the optical axis N₁. In addition, the lens holder 14 and the second sensor holder 24B are joined by melting and solidification, using a laser beam, of end surfaces located in a portion where the second holder fitting margin portion 142b and the second fitting margin portion 242b overlap each other in the radial direction, the portion being outside a region R_{B}4 sandwiched between a retaining surface P_{14B} of the second lens retaining portion 141b and a retaining surface P_{24B} of the second retaining portion 242a in the direction of the optical axis N₂. Here, the “retaining surface P_{14A}^{”} is a plane which passes through a center of a portion where the first lens retaining portion 141a comes into contact with the lens 2c in the direction of the optical axis N₁ and is perpendicular to the optical axis N₁. In addition, the “retaining surface P_{14B}^{”} is a plane which passes through a center of a portion where the second lens retaining portion 141b comes into contact with the lens 2d in the direction of the optical axis N₂ and is perpendicular to the optical axis N₂. In addition, the “retaining surface P_{24A}” is a plane which passes through a center of a portion where the second retaining portion 241a comes into contact with the image sensor 4A in the direction of the optical axis N₁ and is perpendicular to the optical axis N₁. In addition, the “retaining surface P_{24B}” is a plane which passes through a center of a portion where the second retaining portion 242a comes into contact with the image sensor 4B in the direction of the optical axis N₂ and is perpendicular to the optical axis N₂.

With this laser welding, a weld portion 37 is formed on the lens holder 14 and the first sensor holder 24A as melted portions thereof are mixed and solidified. On the other hand, a weld portion 38 is formed on the lens holder 14 and the second sensor holder 24B as melted portions thereof are mixed and solidified. In addition, the lens 2c and the image sensor 4A are respectively retained by the lens holder 14 and the first sensor holder 24A on the same side with respect to the weld portion 37. The lens 2d and the image sensor 4B are respectively retained by the lens holder 14 and the second sensor holder 24B on the same side with respect to the weld portion 38.

The weld portion 37 is formed of a plurality of weld beads 37a, and a weld depth D₁₆ at a central portion in the thickness direction of the lens holder 14 and a weld depth D₁₇ at a central portion in the thickness direction of the first sensor holder 24A are substantially the same.

The weld portion 38 is formed of a plurality of weld beads 38a, and a weld depth D₁₈ at a central portion in the thickness direction of the lens holder 14 and a weld depth D₁₉ at a central portion in the thickness direction of the second sensor holder 24B are substantially the same. Incidentally, it is preferable that the weld depth D₁₆ to the weld depth D₁₉ be substantially the same.

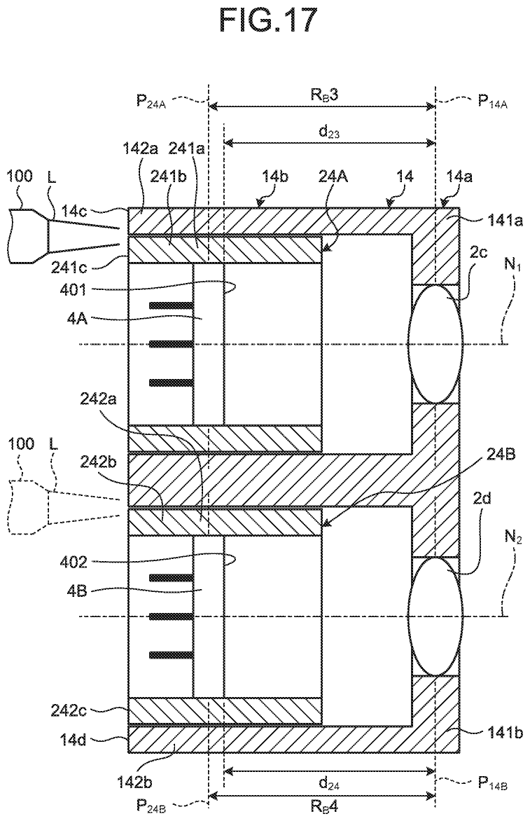

FIG. 17 is a partial cross-sectional view for describing production of the optical unit according to the third embodiment. When producing the optical unit 1F, first, the first sensor holder 24A is inserted into and fitted to the inside of the first holder fitting margin portion 142a from the second retaining portion 241a side. Thereafter, the second sensor holder 24B is inserted into and fitted to the inside of the second holder fitting margin portion 142b from the second retaining portion 242a side. At this time, optical path lengths among the optical devices of the lens holder 14, the first sensor holder 24A, and the second sensor holder 24B are adjusted such that the distance d₂₃ between the lens 2c and the light receiving surface 401 and the distance d₂₄ between the lens 2d and the light receiving surface 402 satisfy the optical conditions. Thereafter, the laser head 100 is arranged to irradiate an edge surface portion, formed of an end surface 14c of the lens holder 14 and an end surface 241c of the first sensor holder 24A, with a laser beam L, thereby melting and solidifying a part of the lens holder 14 and a part of the first sensor holder 24A. Furthermore, an end surface 14d of the lens holder 14 and an end surface 242c of the second sensor holder 24B are irradiated with the laser beam L to melt and solidify a part of the lens holder 14 and a part of the second sensor holder 24B.

In the third embodiment described above, each of the weld portions 37 and 38 having the same weld depths is formed by emitting the laser beam to the end surfaces located in the portion where the holders to be joined overlap each other in the radial direction orthogonal to the optical axis direction, the portion outside the regions each of which is sandwiched between the retaining surface of the retaining portion that retains the device on one end and the retaining surface of the retaining portion that retains the device on the other end in the direction of the optical axis, in the lens holder 14, the first sensor holder 24A, and the second sensor holder 24B, thereby joining the holders. As a result, shrinkage amounts and moving directions of the holder to be joined at the time of laser welding become the same. As a result, it is possible to weld the lens holder 14, the first sensor holder 24A, and the second sensor holder 24B while suppressing relative positional deviations among the optical devices retained by the respective holders even if shrinkage occurs due to melting and solidification. In this manner, it is possible to obtain the optical unit having desired optical characteristics even when the holders are joined by welding according to the third embodiment.

### Fourth Embodiment

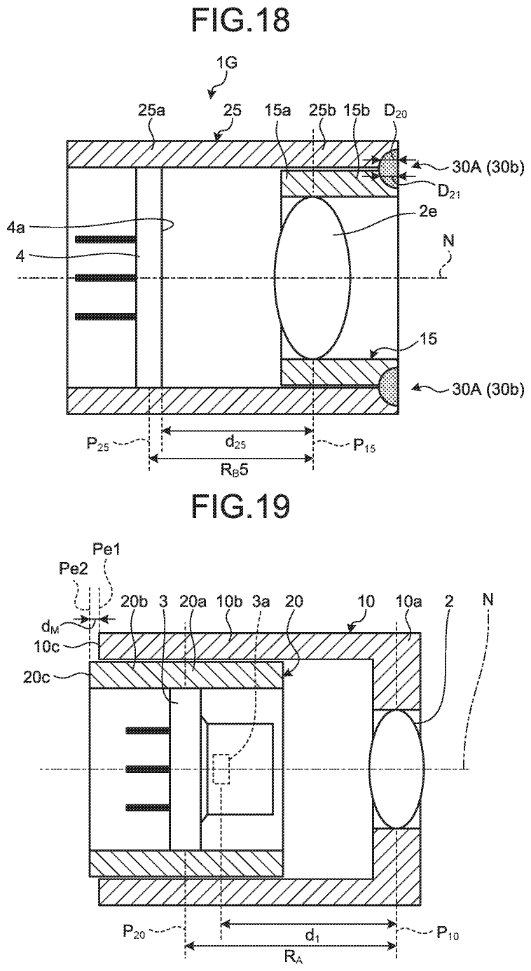

FIG. 18 is a cross-sectional view schematically illustrating a configuration of an optical unit according to a fourth embodiment, and is a partial cross-sectional view taken along a plane including an optical axis of the optical unit as a section. Although the description has been given assuming that the laser holder or the sensor holder is fitted into the lens holder in the above-described first to third embodiments, a lens holder 15 is fitted into a sensor holder 25 in the fourth embodiment.

An optical unit 1G illustrated in FIG. 18 includes: a lens 2e; the substantially cylindrical lens holder 15 which retains the lens 2e; the image sensor 4 described above; and the cylindrical sensor holder 25 which retains the image sensor 4. In FIG. 18, a description will be given assuming that a central axis of the lens holder 15 and a central axis of the sensor holder 25 coincide with each other and coincide with the optical axis N of the optical unit 1G. In the fourth embodiment, the lens holder 15 corresponds to a first optical device retaining body, and the sensor holder 25 corresponds to a second optical device retaining body. In addition, the lens 2e is a first optical device.

The lens holder 15 includes: an annular first retaining portion 15a which retains the lens 2e; and a cylindrical first fitting margin portion 15b which extends along the direction of the optical axis N toward a side opposite to the image sensor 4 from an end of the first retaining portion 15a in the direction of the optical axis N and is fitted with the sensor holder 25. The lens 2e is fixed to the first retaining portion 15a by, for example, soldering or adhesion using an adhesive.

In the sensor holder 25, a diameter of an inner wall surface, the diameter in a direction orthogonal to the optical axis N is equal to a diameter of an outer circumference of the lens holder 15. The sensor holder 25 includes: a second retaining portion 25a which retains the image sensor 4; and a cylindrical second fitting margin portion 25b which extends along the direction of the optical axis N toward the lens 2e from an end of the second retaining portion 25a in the direction of the optical axis N and is fitted with the lens holder 15. The image sensor 4 is fixed to the second retaining portion 25a by, for example, laser welding. Incidentally, a diameter of an inner wall surface of the second fitting margin portion 25b is the same as the diameter of the outer circumference of the lens holder 15, but it is sufficient that the diameter of the inner wall surface of the second fitting margin portion 25b is a diameter that allows fitting of the lens holder 15.

In the optical unit 1G, a distance d₂₅ between the lens 2e and the light receiving surface 4a of the image sensor 4 is a distance that satisfies a preset optical condition.

In addition, the lens holder 15 and the sensor holder 25 are joined by melting and solidification, using a laser beam, of an edge surface portion in which ends are aligned, the ends located in a portion where the first fitting margin portion 15b and the second fitting margin portion 25b overlap each other in the radial direction, the portion on the outer side in the direction of the optical axis N of a region R_{B}5 sandwiched between a retaining surface P₁₅ of the first retaining portion 15a and a retaining surface P₂₅ of the second retaining portion 25a in the direction of the optical axis N. Here, the “retaining surface P₁₅” is a plane which passes through a center of a portion where the first retaining portion 15a comes into contact with the lens 2e in the direction of the optical axis N and is perpendicular to the optical axis N. In addition, the “retaining surface P₂₅” is a plane which passes through a center of a portion where the second retaining portion 25a comes into contact with the image sensor 4 in the direction of the optical axis N and is perpendicular to the optical axis N. With this laser welding, a weld portion 30A is formed on the lens holder 15 and the sensor holder 25 as melted portions thereof are mixed and solidified. In addition, the lens 2e and the image sensor 4 are respectively retained by the lens holder 15 and the sensor holder 25 on the same side with respect to the weld portion 30A in the optical unit 1G. The weld portion 30A is formed of a plurality of weld beads 30b, and a weld depth D₂₀ at a central portion in the thickness direction of the lens holder 15 and a weld depth D₂₁ at a central portion in the thickness direction of the sensor holder 25 are substantially the same.

When producing the optical unit 1G, first, the lens holder 15 is inserted into the second fitting margin portion 25b from the first retaining portion 15a side. At this time, a position of the lens holder 15 with respect to the sensor holder 25 is adjusted the distance d₂₅ between the lens 2e and the light receiving surface 4a becomes the distance that satisfies the optical condition. Thereafter, the above-described position of the sensor holder 25 on an outer surface is irradiated with a laser beam to melt and solidify a part of the lens holder 15 and a part of the sensor holder 25. In the fourth embodiment, it is preferable to inject a cooling gas into the sensor holder 25 to forcibly solidify a melted portion on the inner side of the sensor holder 25, or to use a protective member such as a cover that protects the light receiving surface 4a of the image sensor 4 in order to prevent a part of the melted holder from adhering to the lens 2e.

In the fourth embodiment described above, the lens holder 15 and the sensor holder 25 are joined by forming the weld portion 30A in which the weld depth D₂₀ of the lens holder 15 and the weld depth D₂₁ of the sensor holder 25 are substantially the same outside the region R_{B}5 in which the first fitting margin portion 15b and the second fitting margin portion 25b overlap each other and which is sandwiched between the retaining surface P₁₅ of the first retaining portion 15a and the retaining surface P₂₅ of the second retaining portion 25a, which is similar to the first embodiment. As a result, shrinkage amounts and moving directions of the lens holder 15 and the sensor holder 25 at the time of laser welding become the same. As a result, it is possible to weld the lens holder 15 and the sensor holder 25 while suppressing relative positional deviations among the optical devices retained by the respective holders even if shrinkage occurs due to melting and solidification. In this manner, it is possible to obtain the optical unit having desired optical characteristics even when the holders are joined by welding according to the fourth embodiment.

In addition, it is configured such that the lens holder 15 is not arranged on an outer circumference of the sensor holder 25 that retains the image sensor 4, which is hardly reduced in size as compared with the lens 2e, by inserting the lens holder 15 into the sensor holder 25 according to the fourth embodiment described above. As a result, it is possible to reduce a diameter of the optical unit 1G depending on the size of the image sensor 4.

### Fifth Embodiment

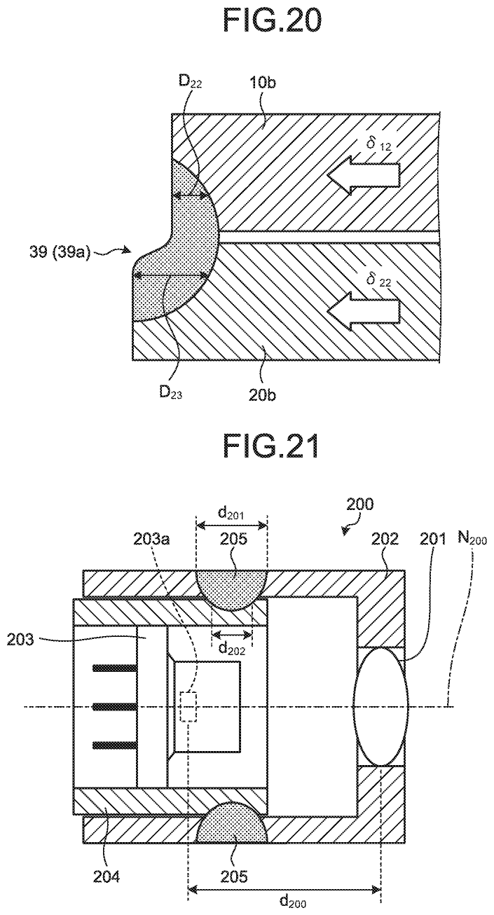

FIG. 19 is a partial cross-sectional view for describing production of an optical unit according to a fifth embodiment. FIG. 20 is a cross-sectional view schematically illustrating a configuration of a main part of the optical unit according to the fifth embodiment. Although the description has been given assuming that welding is performed in the state where the end surfaces of the respective holders to be welded are aligned in the direction perpendicular to the direction of the optical axis N in the above-described first to fourth embodiments, there is a case where end surfaces of holders after adjustment of an optical path length are different depending on positions where optical devices are retained by the retaining portions.

At this time, if moving directions of the respective optical devices caused by shrinkage are made the same by performing welding as described above, it is possible to minimize positional deviations among the optical devices caused by the welding. For example, in a case where a weld depth D₂₂ is 0.1 mm, a weld depth D₂₃ is 0.2 mm, and the moving directions of the optical devices caused by shrinkage are the same, a difference between a shrinkage amount δ₁₂ and a shrinkage amount δ₂₂ is estimated to be 0.005 mm or less, and may be regarded as a deviation within the range satisfying optical characteristics if the relationship between the weld width and the dimensional change amount as illustrated in FIG. 5 is used. When the moving directions of the optical devices caused by shrinkage are opposite to each other, an optical path length becomes twice the difference, but when the moving directions of the optical devices caused by shrinkage are the same, the optical path length becomes 0.005 mm or less and it is possible to produce the optical unit 1 satisfying the optical characteristics even if the end surface 10c and the end surface 20c are misaligned. Assuming that the positional deviation amount between the end surface 10c and the end surface 20c at this time is d_{M}, the deviation amount d_{M} is smaller than the distance d₁ between the lens 2 and the light source 3a of the semiconductor laser 3. As described above, the optical path length of the optical unit 1 is adjusted between 20 μm and 50 μm, and the deviation amount d_{M} in this case falls within the range of several microns to several tens of microns.

FIG. 19 illustrates a state where the laser holder 20 is moved relative to the lens holder 10 to adjust the optical path length between the lens 2 and the semiconductor laser 3. In FIG. 19, a plane Pe1 which passes through the end surface 10c and is perpendicular to the direction of the optical axis N, and a plane Pe2 which passes through the end surface 20c and is perpendicular to the direction of the optical axis N deviate from each other. When welding is performed in this state, a weld portion 39 having different weld depths in the respective holders is formed. The weld portion 39 is formed of a plurality of weld beads 39a. In the weld portion 39, the weld depth D₂₂ at a central portion in the thickness direction of the lens holder 10 and the weld depth D₂₃ at a central portion in the thickness direction of the laser holder 20 are different.

When the weld depth D₂₂ and the weld depth D₂₃ are different, the shrinkage amount δ₁₂ of the lens holder 10 and the shrinkage amount δ₂₂ of the laser holder 20 are also different. As a result, an optical path length after welding changes. In the fifth embodiment, however, the moving directions of the holders caused by the shrinkage are the same, and a deviation amount of the optical path length is small as compared with the known configuration in view of the fact that a distance in the direction of the optical axis N between the surface Pe1 and the surface Pe2 is also in the order of microns so that deviation amount of the optical path length corresponds to a deviation of the range established as the optical unit 1.

The modes for carrying out the present disclosure have been described hereinbefore. However, the present disclosure is not limited only to the embodiments described above.

In addition, the description has been given assuming that the holders are joined by performing the laser welding using the laser beam in the above-described first to fifth embodiments, but the joining method is not limited thereto. For example, known welding techniques such as electron beam welding and resistance welding may also be used. Meanwhile, in the case of using a contact-type welding device, it is preferable to fix holders more firmly than in the case of performing contactless welding in order to prevent a positional deviation between holders at the time of welding.

In addition, the description has been given assuming that the second optical device retaining body retains only the semiconductor laser or the image sensor in the above-described first to fifth embodiments, but the second optical device retaining body may further retain a lens corresponding to an optical device. In this case, the second optical device retaining body retains the plurality of optical devices using the second retaining portion.

In addition, each of the first and second optical devices described above is an element that transmits light or converts the light into another energy, such as a lens, a lens group formed of a plurality of bonded or mutually independent lenses, an optical fiber, an optical waveguide optical isolator, a semiconductor laser, a light emitting element, a light receiving element, an optical amplifier, an imaging element, and a photoelectric conversion element, and is one selected from the element itself and a device including any of these elements.

In addition, in the above-described first to fifth embodiments, the holders forming a pair to be joined may have mutually different shapes viewed from the direction of the optical axis N as long as the holders may be joined by welding, are not necessarily fitted with each other in the entire portion where the holders overlap each other in the direction orthogonal to the optical axis N, but may be partially fitted. As long as positioning between the optical devices in the direction orthogonal to the optical axis N is possible, the overlapping portion may have a gap.

In this manner, the present disclosure may include various embodiments within a range not departing from the technical ideas described in the claims.

As described above, the optical unit according to the present disclosure is advantageous to obtain a unit having desired optical characteristics even when holders that hold optical devices are joined by welding.

According to the present disclosure, an effect that an optical unit having desired optical characteristics may be obtained is achieved even when holders that respectively retain optical devices are joined by welding.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical unit comprising:
a first optical device retaining body having a sleeve-shape and including
a first retainer configured to retain a first optical device thereinside, and
a first fitting margin extending from the first retainer;
a second optical device retaining body having a sleeve-shape and including
a second retainer configured to retain a second optical device thereinside, and
a second fitting margin extending from the second retainer, wherein the first fitting margin and the second fitting margin are fitted with each other, and the optical unit is fixed by welding at an overlapping portion of the first fitting margin and the second fitting margin; and
a weld portion melted and solidified across the first fitting margin and the second fitting margin, the weld portion being provided in an edge surface located outside a region in an optical axis direction of the optical unit, the region being sandwiched by: a first retaining surface passing through the first retainer and perpendicular to the optical axis of the optical unit; and a second retaining surface passing through the second retainer and perpendicular to the optical axis, wherein ends of the first fitting margin and the second fitting margin in the optical axis direction in the overlapping portion are substantially aligned at the edge surface.

2. The optical unit according to claim 1, wherein the weld portion is formed such that a first weld depth of the first fitting margin and a second weld depth of the second fitting margin are substantially identical in the optical axis direction.

3. The optical unit according to claim 2, wherein a ratio of the second weld depth relative to the first weld depth is between 0.75 and 1.25.

4. The optical unit according to claim 2, wherein the weld portion is formed such that a first weld width of the first fitting margin and a second weld width of the second fitting margin are substantially identical in a direction perpendicular to the optical axis direction.

5. The optical unit according to claim 2, wherein
the weld portion is formed of a plurality of weld beads,
the weld bead includes at least a part symmetric with respect to a mating surface in a cross section perpendicular to the mating surface passing through the overlapping portion between the first fitting margin and the second fitting margin, and parallel to the optical axis.
